(19) United States
(12) Patent Application Publication
(10) Pub. No.: US 2026/0302660 A1
(43) Pub. Date: Oct. 1, 2026

(54) CONNECTOR AND CONNETOR DIVECE

(71) Applicant: Japan Aviation Electronics Industry, Limited, Tokyo (JP)

(72) Inventor: Takashi OMODACHI, Tokyo (JP)

(21) Appl. No.: 19/478,539

(22) PCT Filed: Dec. 27, 2023
(86) PCT No.: PCT/JP2023/047035

§ 371 Date: Oct. 24, 2025

(30) Foreign Application Priority Data
Jun. 26, 2023 (JP) 2023-104514
Jun. 26, 2023 (JP) 2023-104515

(51) Int. Cl. H01R 12/70; H01R 12/71

(52) U.S. Cl. CPC H01R 12/7005; H01R 12/716

(57) ABSTRACT

A connector includes a housing, a plurality of terminals, and two additional members, and each of the additional members includes two locking mechanisms located to face each other in a second direction. The locking mechanism includes a spring portion, an extension portion, a locking portion, and an operating portion, the operating portion is movable between a non-release position and a release position that is located closer to the outer side of the connector than the non-release position in the second direction when a pressing operation is undergone toward the outer side of the connector in the second direction, and when the operating portion moves from the non-release position to the release position, the locking portion, which moves in conjunction with the operating portion, moves with a larger amount of movement in the second direction than the operating portion.

### TECHNICAL FIELD

The present invention relates to a connector, and a connector device including a connector and an unlocking jig that can be used with the connector.

### BACKGROUND ART

Conventionally, there is known a connector that, by moving a mating connector in a third direction (for example, an up-down direction) orthogonal to a virtual plane formed by a first direction (for example, a left-right direction) and a second direction (for example, a front-rear direction) that are orthogonal to each other, can be fitted with or removed from the mating connector. Some connectors of this type include a locking mechanism that holds a fitted state with the mating connector.

For example, Patent Literature 1 listed below discloses a connector including a locking mechanism as shown in FIG. 28. That is, a connector (100) disclosed in Patent Literature 1 includes a total of four restriction mechanisms (500) provided two by two in each of two additional members (400) in the connector (100). Each of the four restriction mechanisms (500) includes a plate-like spring member having a U-shape, a protrusion (511) as a locking portion is formed on a root side of the spring member that is elastically deformable, and an operating portion (550) is formed on a leading end side of the spring member. An operator inserts a release jig (not shown) and presses a pressed portion (552) provided on the operating portion (550) outward on both sides, whereby the protrusion (511) formed on the root side of the spring can be moved. In other words, the protrusion (511) is engaged with the mating connector to hold a fitted state between the connectors, and the protrusion (511) separates from the mating connector to release the fitted state between the connectors. Note that the symbols described in citation list are in parentheses to distinguish from those in an embodiment of the present invention.

### CITATION LIST

### Patent Literature

Patent Literature 1: Japanese Patent Laid-Open No. 2018-181824

### SUMMARY OF INVENTION

### Technical Problem

However, in the structure of the spring member provided in the connector disclosed in Patent Literature 1 described above, it is necessary to ensure that the amount of displacement of the operating portion (550) located on the leading end side of the spring member is larger than the amount of displacement of the protrusion (511) as the locking portion located on the root side of the spring member that is elastically deformable. For this reason, in order to ensure the amount of displacement of the protrusion (511), which is responsible for holding and releasing the fitted state between the connectors, it is necessary to increase a dimension (amount of protrusion) by which the operating portion (550) protrudes in a direction of displacement in a space into which the jig is inserted. Therefore, when the release jig is inserted from above the connector (100) in particular, there is a risk that when the locking mechanism is released, the release jig butts against a portion of the operating portion (550) that protrudes significantly into the space, and erroneously presses down the operating portion, causing the spring member to buckle.

Accordingly, the present invention aims to provide a connector that can set the amount of displacement of the operating portion to be small while ensuring a sufficient amount of displacement of the locking portion, which is responsible for holding and releasing the fitted state between the connectors, and therefore can set the amount of protrusion of the operating portion to be small in the space into which the release jig is inserted, thereby preventing the release jig from erroneously pressing down the operating portion and causing the plate-like spring member (elastic member) to buckle, and a connector device including the connector and an unlocking jig that can be used with the connector.

### Solution to Problem

A connector according to the present invention is a connector that, by moving a mating connector in a third direction orthogonal to a virtual plane formed by a first direction and a second direction that are orthogonal to each other, is fitted with or removed from the mating connector, the connector includes a housing, a plurality of terminals, and two additional members, the plurality of terminals are held in the housing and arranged in a direction along the first direction, the two additional members are held in the housing and located at both ends of the housing in the first direction, each of the two additional members includes two locking mechanisms located to face each other in the second direction, each of the two locking mechanisms includes a spring portion, an extension portion, a locking portion, and an operating portion, the spring portion is a plate-like elastic member having a U-shape that is closed at an outer side of the connector and open at an inner side thereof in the first direction when viewed in the third direction, an end of the U-shape on the outer side of the connector in the second direction being formed as a fixed end, an end of the U-shape on the inner side of the connector in the second direction being formed as a free end, the extension portion is formed to be continuous with the end on the inner side of the connector in the second direction, which is formed as the free end of the spring portion having the U-shape, and to extend in the first direction, and is capable of being displaced in the second direction by an elastic force of the spring portion, the locking portion is formed on the inner side of the connector in the second direction of the extension portion, and includes a locking surface that faces one side in the third direction, the operating portion is located between the spring portion and the locking portion in the first direction of the extension portion, and is formed on the inner side of the connector in the second direction of the extension portion, the operating portion is movable between a non-release position and a release position that is located when a pressing operation is undergone toward the outer side of the connector in the second direction and is located closer to the outer side of the connector than the non-release position in the second direction, and when the operating portion moves from the non-release position to the release position, the locking portion, which moves in conjunction with the operating portion, moves with a larger amount of movement in the second direction than the operating portion.

That is, according to the connector of the present invention, the operating portion is formed on the root side of the plate-like elastic member having the U-shape, and the locking portion is formed on the leading end side of the plate-like elastic member, whereby when the operating portion moves from the non-release position to the release position, the locking portion, which moves in conjunction with the operating portion, can move with a larger amount of movement than the operating portion. In other words, the amount of movement of the operating portion can be made smaller than that of the locking portion. Therefore, the amount of movement of the operating portion required to ensure the amount of displacement of the locking portion can be made small, and the amount of protrusion in the direction of movement of the operating portion in a state of waiting for the insertion of the unlocking jig can be reduced, thereby preventing irregular deformation of the plate-like elastic member caused by erroneously pressing down the protrusion portion with the unlocking jig, and preventing the buckling of the elastic member due to the irregular deformation. In addition, according to the configuration of the present invention, the amount of movement of the operating portion required for unlocking is small compared to the related art, and thus the operability of unlocking, which is perform by inserting the unlocking jig, is improved compared to the related art. Furthermore, the amount of hooking of the locking portion can be set to be large, which has the effect of achieving a more reliable and stronger locking mechanism.

In the connector according to the present invention, each of the two additional members further includes a top plate and a bent portion, the top plate is formed at a position at which the spring portion and the extension portion are at least partially covered when viewed along the one side in the third direction, and expands in parallel with a virtual plane formed by the first direction and the second direction, and the bent portion is formed into a curved and bent shape to connect the end on the outer side of the connector in the second direction, of the U-shape that constitutes the spring portion, and the top plate.

In the connector according to the present invention, each of the two additional members further includes a hold-down, the hold-down is continuous with an end of the top plate formed on the inner side of the connector in the first direction, and extends from the end to the one side in the third direction, the hold-down includes a soldering portion at a terminal end opposite to a side connected to the end, and when the connector is placed on a board arranged on a side facing the one side in the third direction, the soldering portion is solderable to the board.

In the connector according to the present invention, each of the two additional members further includes a restriction portion, the restriction portion includes a restricting surface that is fixed to the top plate and faces the one side in the third direction, the extension portion is formed with a restricted surface that faces the other side in the third direction, when the operating portion is at the non-release position, the restricting surface faces the restricted surface in the third direction, and when the restricted surface butts against the restricting surface in the third direction, movement of the locking portion toward the other side in the third direction is restricted.

In the connector according to the present invention, preferably, the locking portion and the restricted surface at least partially overlap each other in positions in the first direction on the extension portion.

A connector device according to the present invention includes the connector and an unlocking jig, the connector includes, on each of both sides in the first direction, a total of at least two abutted surfaces, which are flat surfaces perpendicular to the third direction and facing the other side in the third direction, on the housing or the additional member, the abutted surfaces having different positions in the third direction, the unlocking jig includes a total of two pressing leg portions that are insertable into a gap between the two locking mechanisms, which are located to face each other in the second direction and are provided on each of the two additional members, by moving to approach toward the connector along the one side in the third direction, each of the pressing leg portions includes a total of two pressing operation surfaces that are located to face outward on both sides in the second direction when being inserted into the gap between the two locking mechanisms and move each of the two operating portions of the two locking mechanisms from the non-release position to the release position by the insertion of the pressing leg portions, and each of the pressing leg portions may further include at least two abutting surfaces, which are flat surfaces perpendicular to the third direction and facing the one side, when being inserted into the gap between the two locking mechanisms, the abutting surfaces having different positions in the third direction and abutting against the at least two abutted surfaces, respectively, by the insertion of the pressing leg portions.

A connector device according to the present invention includes the connector and an unlocking jig, the connector includes, on each of both sides in the first direction, a total of at least two abutted surfaces, which are flat surfaces perpendicular to the third direction and facing the other side in the third direction, on the housing or the top plate, the abutted surfaces having different positions in the third direction, the unlocking jig includes a total of two pressing leg portions that are insertable into a gap between the two locking mechanisms, which are located to face each other in the second direction and are provided on each of the two additional members, by moving to approach toward the connector along the one side in the third direction, each of the pressing leg portions includes a total of two pressing operation surfaces that are located to face outward on both sides in the second direction when being inserted into the gap between the two locking mechanisms and move each of the two operating portions of the two locking mechanisms from the non-release position to the release position by the insertion of the pressing leg portions, and each of the pressing leg portions further includes at least two abutting surfaces, which are flat surfaces perpendicular to the third direction and facing the one side, when being inserted into the gap between the two locking mechanisms, the abutting surfaces having different positions in the third direction and abutting against the at least two abutted surfaces, respectively, by the insertion of the pressing leg portions.

In the connector device according to the present invention, each of the two additional members of the connector includes a connector-side sliding surface that is a flat surface perpendicular to the first direction and facing an outer side of the connector in the first direction and is elastically deformable in the first direction, the connector-side sliding surface being formed with a connector-side operation feeling imparting portion which is either a protrusion portion or a recess portion, each of the pressing leg portions of the unlocking jig includes a jig-side sliding surface that is a flat surface perpendicular to the first direction and facing the inner side of the connector in the first direction when being inserted into the gap between the two locking mechanisms, the jig-side sliding surface being formed with a jig-side operation feeling imparting portion which is either a protrusion portion or a recess portion, and when the at least two abutted surfaces abut against the at least two abutting surfaces by inserting the pressing leg portion into the gap between the two locking mechanisms, the connector-side operation feeling imparting portion and the jig-side operation feeling imparting portion are capable of imparting operation feeling to an operator, who operates the unlocking jig, by being fitted with each other.

### Advantageous Effects of Invention

According to the present invention, since there in no need to set the amount of displacement of the operating portion to be large in order to ensure the amount of displacement of the locking portion, the amount of protrusion of the operating portion in the space into which the unlocking jig is inserted to release the locking mechanism of the connector, more specifically, in the space formed by the gap between two locking mechanisms facing each other in the second direction, can be set small, and therefore a connector can be provided which prevents irregular deformation of the plate-like elastic member caused by erroneously pressing down the protrusion portion with the unlocking jig, and prevents the buckling of the elastic member due to the irregular deformation. In addition, according to the present invention, a connector can be provided in which the amount of movement of the operating portion required for unlocking is small, and thus the operability of unlocking is improved compared to the related art. In addition, according to the present invention, since the amount of hooking of the locking portion can be set to be large, a connector can be provided that achieves a more reliable and stronger locking mechanism. Furthermore, according to the connector device of the present invention, the posture of the unlocking jig in contact with the connector can be readily stabilized, and thus malfunctions such as twisting of the unlocking jig can be suitably prevented. In addition, click feeling can be imparted to the unlocking operation using the unlocking jig.

### BRIEF DESCRIPTION OF DRAWINGS

FIG. 1 is an upper perspective view showing a connector and a mating connector of the present embodiment.

FIG. 2 is a top view showing the connector and the mating connector in FIG. 1.

FIG. 3 is a bottom view showing the connector and the mating connector in FIG. 1.

FIG. 4 is a front view showing the connector and the mating connector in FIG. 1.

FIG. 5 is a right side view showing the connector and the mating connector in FIG. 1.

FIG. 6 is a cross-sectional view showing the connector and the mating connector in FIG. 2, taken along line 6-6.

FIG. 7 is a cross-sectional view showing the connector and the mating connector in FIG. 4, taken along line 7-7.

FIG. 8 is an upper perspective view showing a state in which the mating connector is removed from the connector of the present embodiment.

FIG. 9 is a lower perspective view showing the mating connector of the present embodiment.

FIG. 10 is a lower perspective view showing a state in which the mating connector of the present embodiment is exploded.

FIG. 11 is an upper perspective view showing the connector of the present embodiment.

FIG. 12 is an upper perspective view showing a state in which the connector of the present embodiment is exploded.

FIG. 13 is an upper perspective view showing an additional member constituting the connector of the present embodiment.

FIG. 14 is a lower perspective view showing the additional member constituting the connector of the present embodiment.

FIG. 15 is a top view showing the additional member constituting the connector of the present embodiment.

FIG. 16 is a bottom view showing the additional member constituting the connector of the present embodiment.

FIG. 17 is a front view showing the additional member constituting the connector of the present embodiment.

FIG. 18 is a cross-sectional view showing the additional member in FIG. 17, taken along line 18-18.

FIG. 19 is a right side view showing the additional member constituting the connector of the present embodiment.

FIG. 20 is a left side view showing the additional member constituting the connector of the present embodiment.

FIG. 21 is a lower perspective view showing an unlocking jig of the present embodiment.

FIG. 22 is a front view for explaining a method of using the unlocking jig of the present embodiment, showing a state before unlocking of the connector and the mating connector which are fitted with each other. In the drawing, a first circuit board and a second circuit board are indicated by dashed lines.

FIG. 23 is a front view for explaining a method of using the unlocking jig of the present embodiment, showing a state during unlocking of the connector and the mating connector which are fitted with each other. In the drawing, a first circuit board and a second circuit board are indicated by dashed lines.

FIG. 24 is a right side view for explaining a method of using the unlocking jig of the present embodiment, showing a state during unlocking of the connector and the mating connector which are fitted with each other.

FIG. 25 is a cross-sectional view showing the connector, the mating connector, and the unlocking jig in FIG. 24, taken along line 25-25.

FIG. 26 is a cross-sectional view showing the connector, the mating connector, and the unlocking jig in FIG. 24, taken along line 26-26.

FIG. 27 is a view for explaining a relationship between the unlocking jig, the connector, and the mating connector of the present embodiment, showing a perspective view of the connector and the mating connector when viewed from above.

FIG. 28 is a cross-sectional view showing an example of a schematic configuration of a connector according to Patent Literature 1.

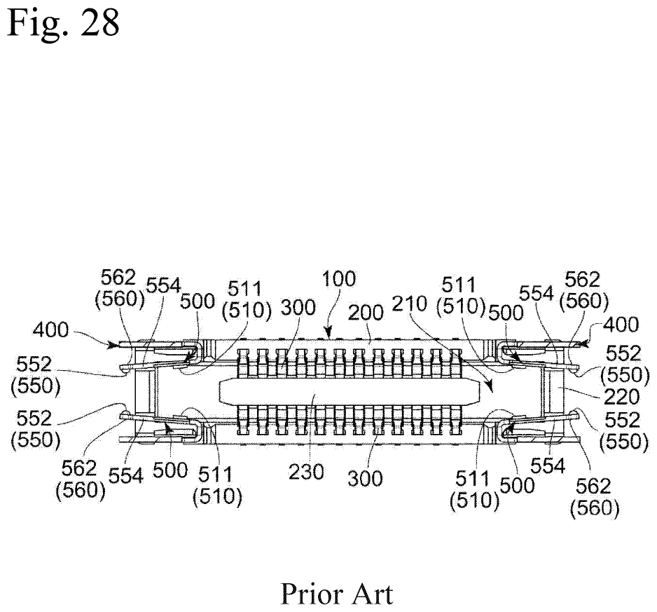

### DESCRIPTION OF EMBODIMENT

Hereinafter, preferred embodiments for carrying out the present invention will be described with reference to the drawings. In the present invention, a first direction, a second direction, and a third direction are defined, and an X direction, a Y direction, and a Z direction are defined in the drawings for convenience of description. In the description, the first direction is a left-right direction. In the drawings, the left-right direction is shown as the X direction. In particular, the right side is defined as +X direction, and the left side is defined as a −X direction. In the description, the second direction is a front-rear direction. In the drawings, the front-rear direction is shown as the Y direction. In particular, the front side is defined as a +Y direction, and the rear side is defined as a −Y direction. In the description, the third direction is an up-down direction. In the drawings, the up-down direction is shown as the Z direction. In particular, the upside is defined as a +Z direction, and the downside is defined as a −Z direction.

Furthermore, the following embodiments do not limit the inventions related to claims, and it cannot be said that the entirety of combinations of characteristics described in the embodiment are essential for the solution to problem.

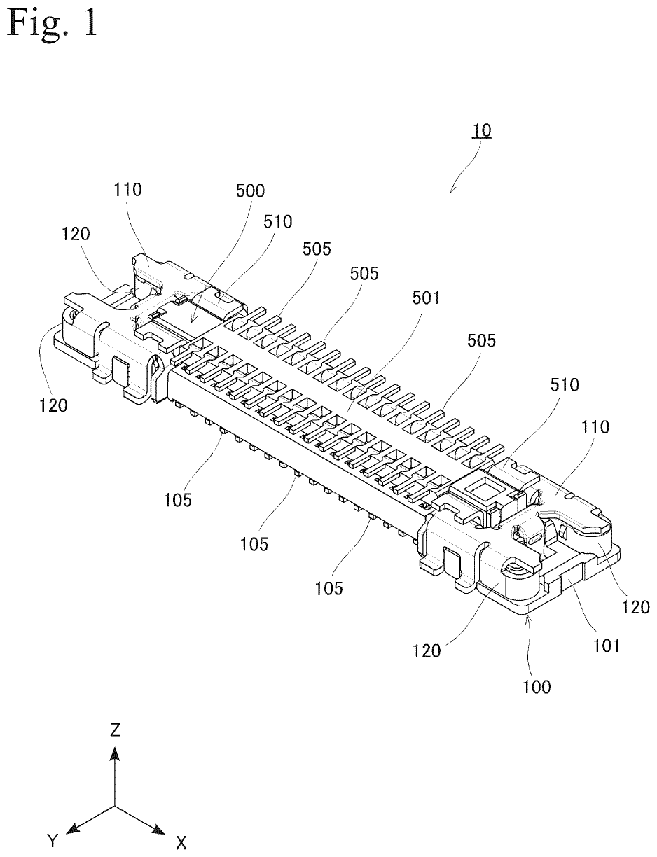

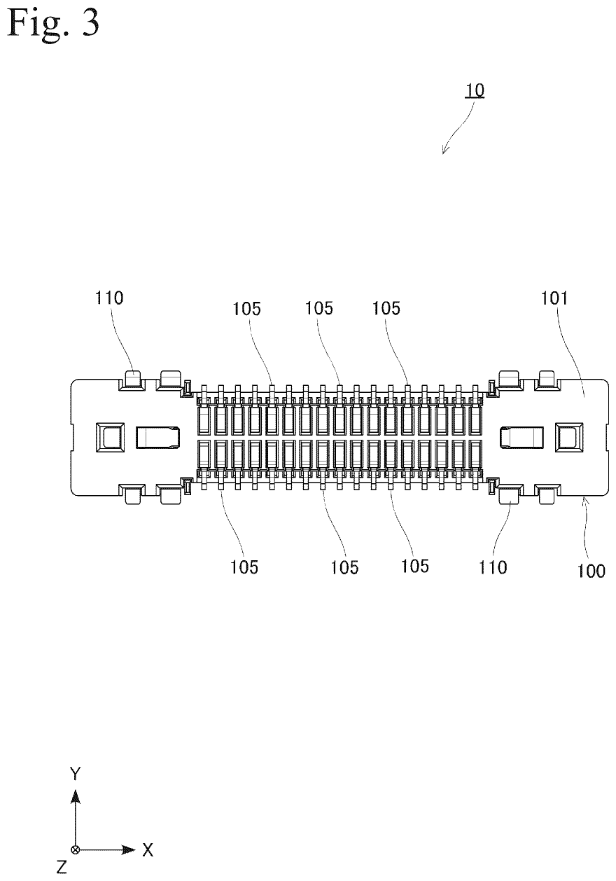

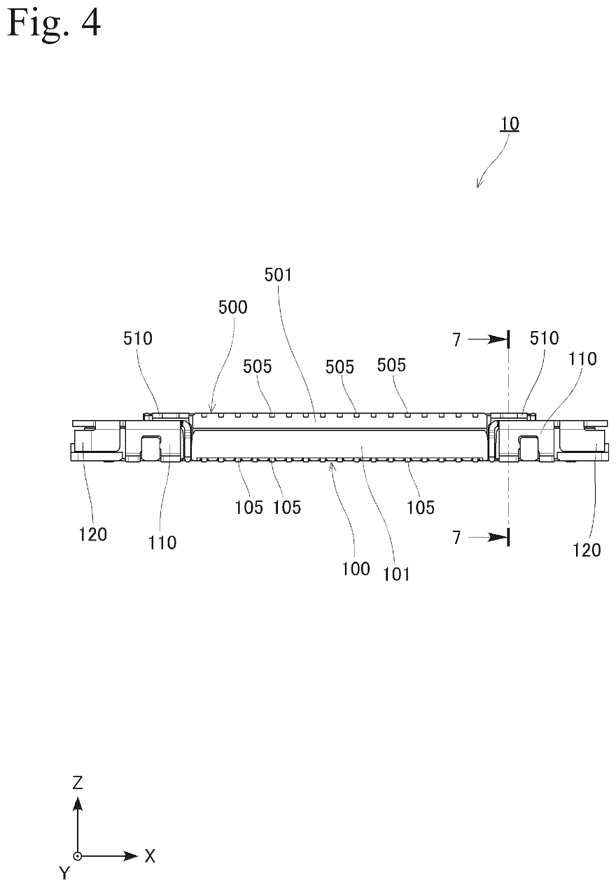

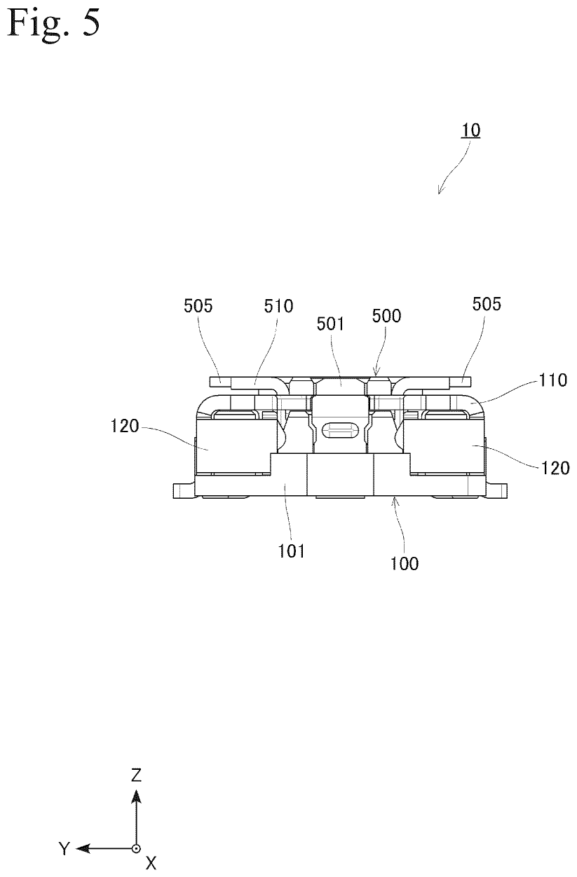

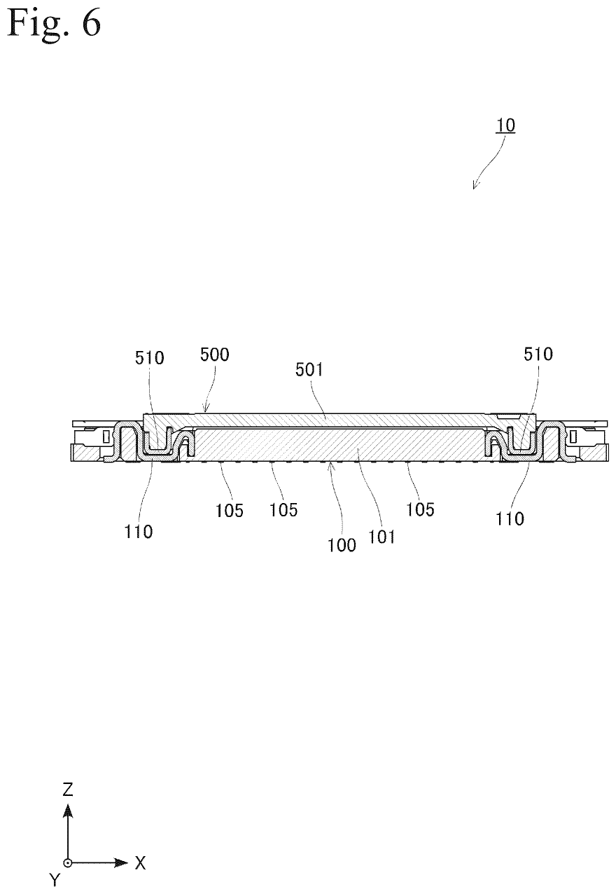

As shown in FIGS. 1 to 7, a connector 100 of the present embodiment constitutes a connector assembly 10 together with a mating connector 500. In the present embodiment, the mating connector 500 is configured as a plug connector, and the connector 100 is configured as a receptacle connector.

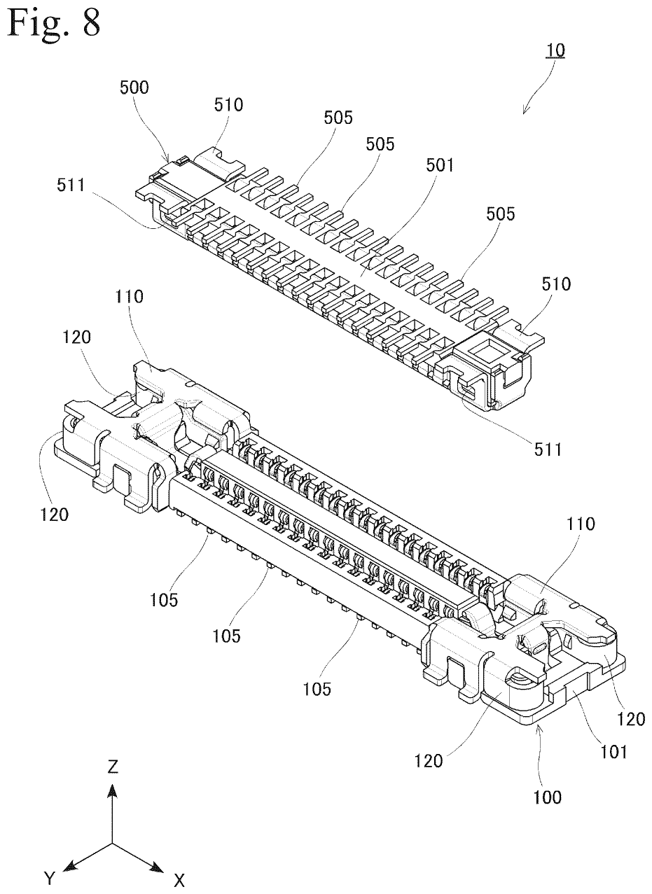

With reference to FIGS. 1 and 8, the connector assembly 10 of the present embodiment is configured such that the mating connector 500 moves in the third direction (Z: up-down direction) orthogonal to a virtual plane formed by the first direction (X: left-right direction) and the second direction (Y: front-rear direction) that are orthogonal to each other, and thus the mating connector 500 is fitted with or removed from the connector 100.

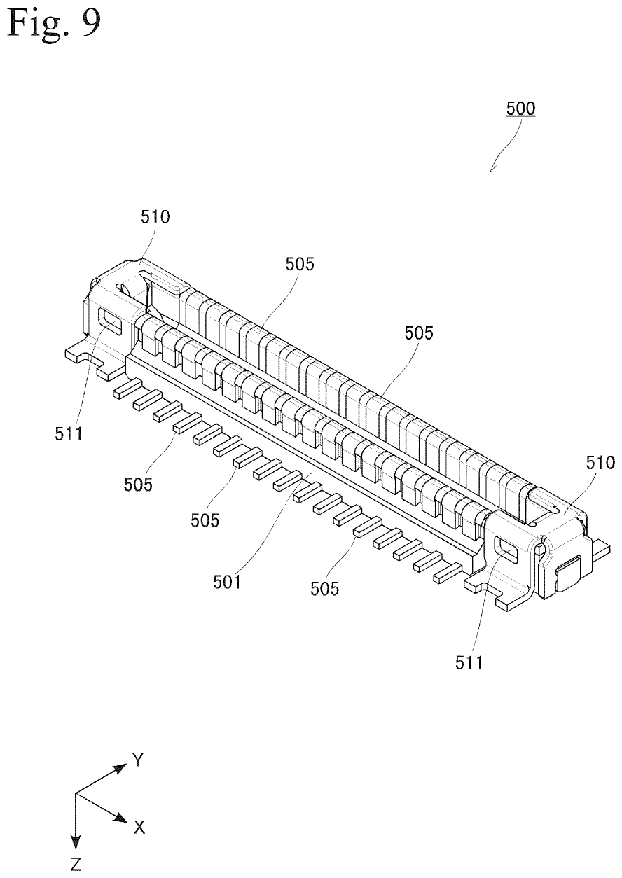

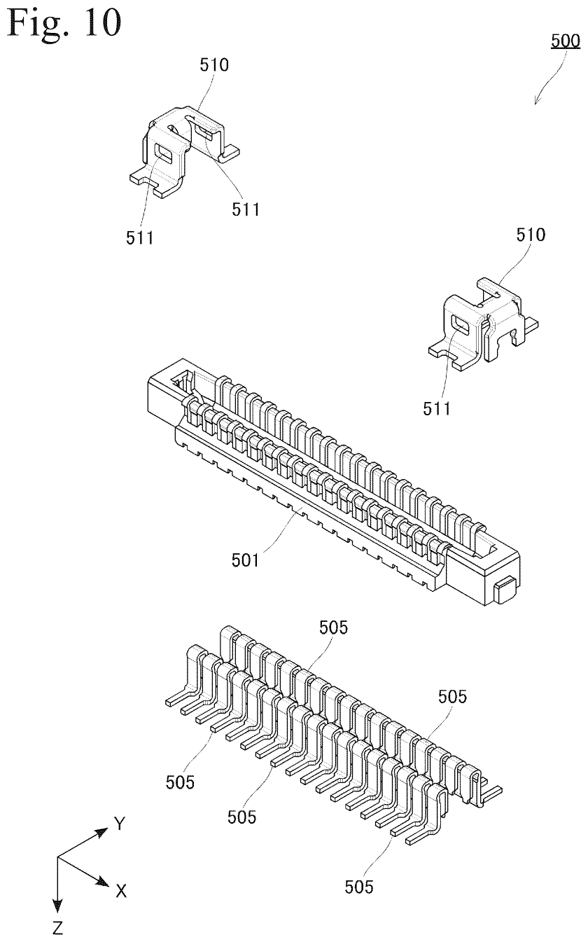

As shown in FIGS. 9 and 10, the mating connector 500 of the present embodiment includes a mating housing 501, a plurality of mating terminals 505, and two mating additional members 510.

The mating housing 501 is a member that functions as an insulator, and is made of a resin material, for example.

The plurality of mating terminals 505 are members that are made of a conductive metal material and are formed, for example, by punching and press processing of a metal plate. The plurality of mating terminals 505 of the present embodiment are held in the mating housing 501 and are arranged in a direction along the left-right direction which is the first direction. The mating housing 501 and the plurality of mating terminals 505 are integrally formed by injection molding, for example.

The two mating additional members 510 are members that are held in the mating housing 501 and are located at both ends of the mating housing 501 in the left-right direction which is the first direction. The two additional members 510 of the present embodiment are fitted, from the downside toward the upside (in the +Z direction), into both ends of the housing 501 including the plurality of terminals 505 integrally formed by injection molding or the like, and are thus attached to the housing 501. The mating additional members 510 are formed of, for example, a metal material.

Furthermore, each of the two mating additional members 510 of the present embodiment includes locking holes 511 on front and rear surfaces. In other words, the mating connector 500 of the present embodiment includes a total of four locking holes 511 formed one by one on front and rear surfaces of each of left and right ends. These four locking holes 511 are engaged with locking portions 123 of a locking mechanism 120 provided in the connector 100, which will be described below, to achieve a locked state, and are configured to hold a state where the mating connector 500 is fitted with the connector 100.

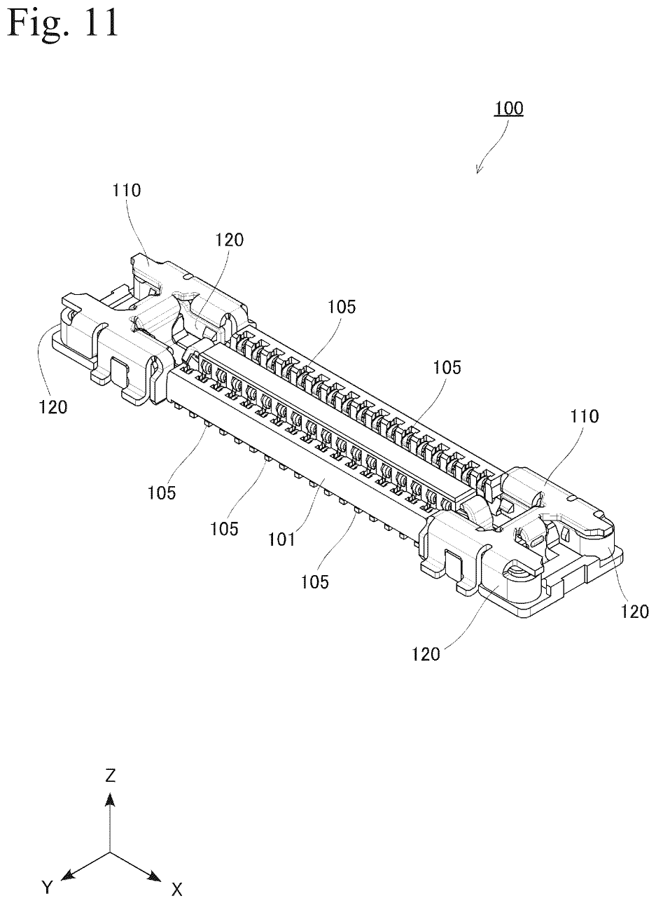

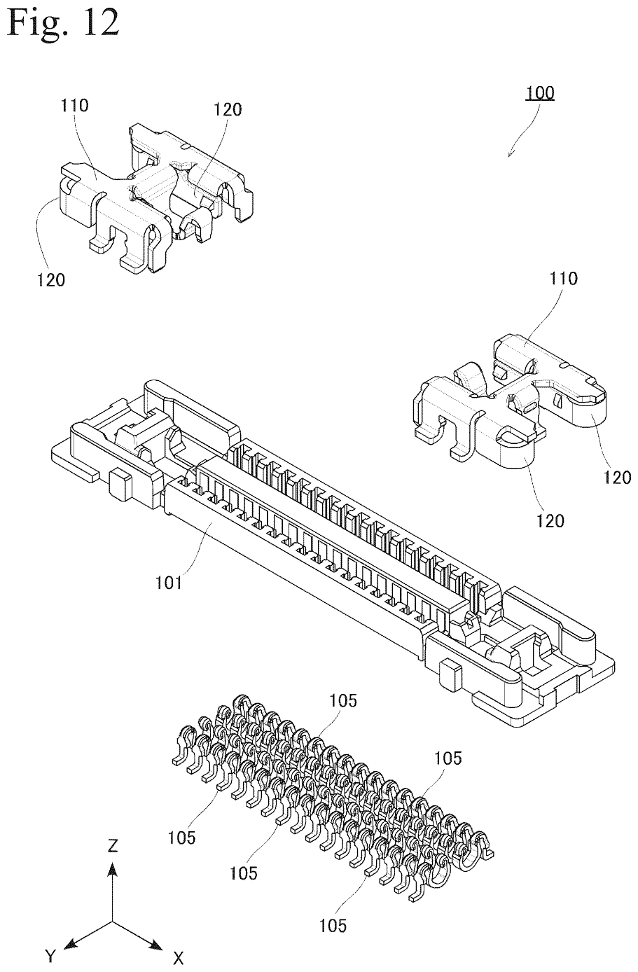

On the other hand, as shown in FIGS. 11 and 12, the connector 100 of the present embodiment includes a housing 101, a plurality of terminals 105, and two additional members 110.

The housing 101 is a member that functions as an insulator, and is made of a resin material, for example.

The plurality of terminals 105 are members that are made of a conductive metal material and are formed, for example, by punching and press processing of a metal plate. The plurality of terminals 105 of the present embodiment are held in the housing 101 and are arranged in a direction along the left-right direction which is the first direction. The housing 101 and the plurality of terminals 105 are integrally formed by injection molding, for example.

The two additional members 110 are members that are held in the housing 101 and are located at both ends of the housing 101 in the left-right direction which is the first direction. The two additional members 110 of the present embodiment are fitted, from the upside toward the downside (in the −Z direction), into both ends of the housing 101 including the plurality of terminals 105 integrally formed by injection molding or the like, and are thus attached to the housing 101. The additional members 110 are formed of, for example, a metal material.

Furthermore, each of the two additional members 110 of the present embodiment includes locking mechanisms 120 that are engaged with the four locking hole 511 provided in the mating connector 500 to achieve a locked state. The locking mechanisms 120 are provided two by two for each of the two additional members 110. In other words, the connector 100 includes a total of four locking mechanisms 120 formed two by two on each of left and right ends.

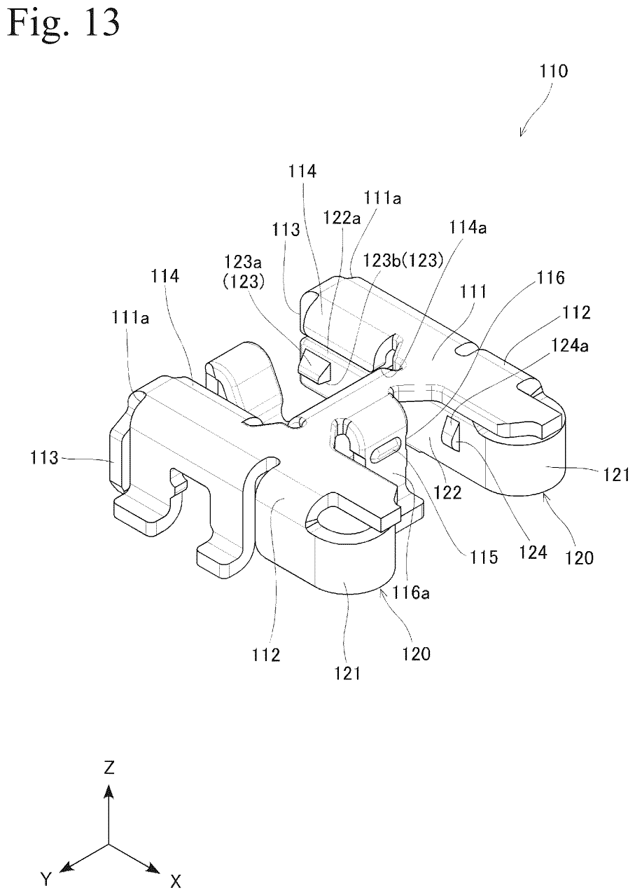

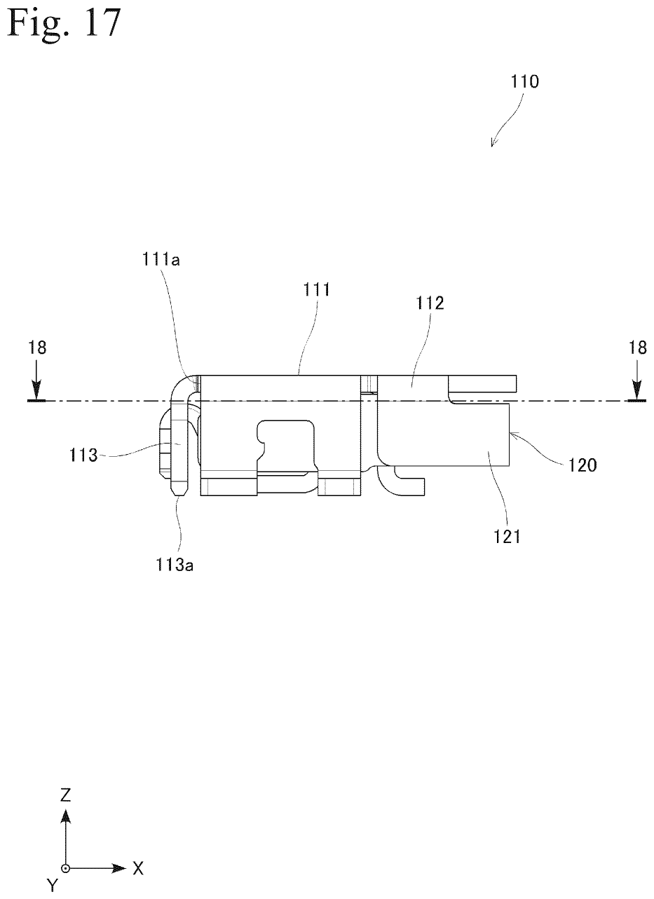

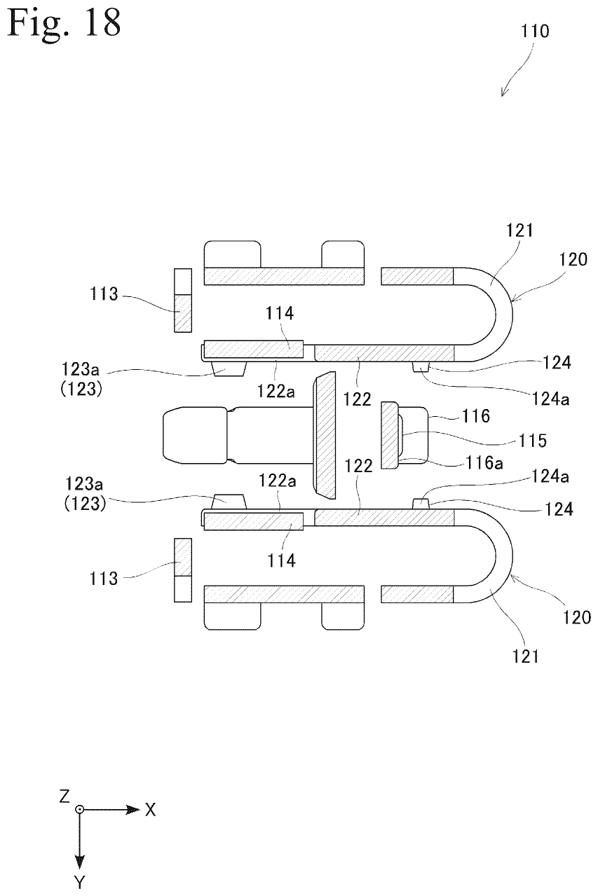

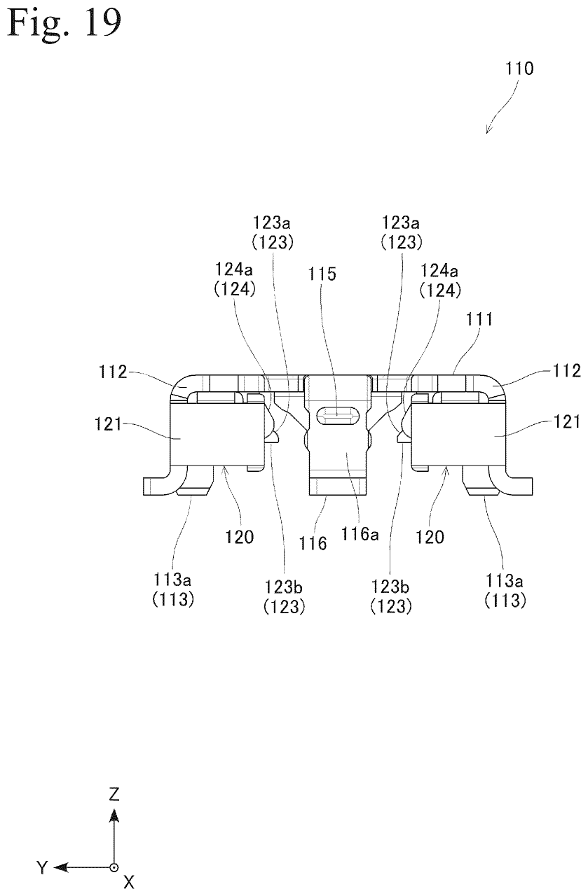

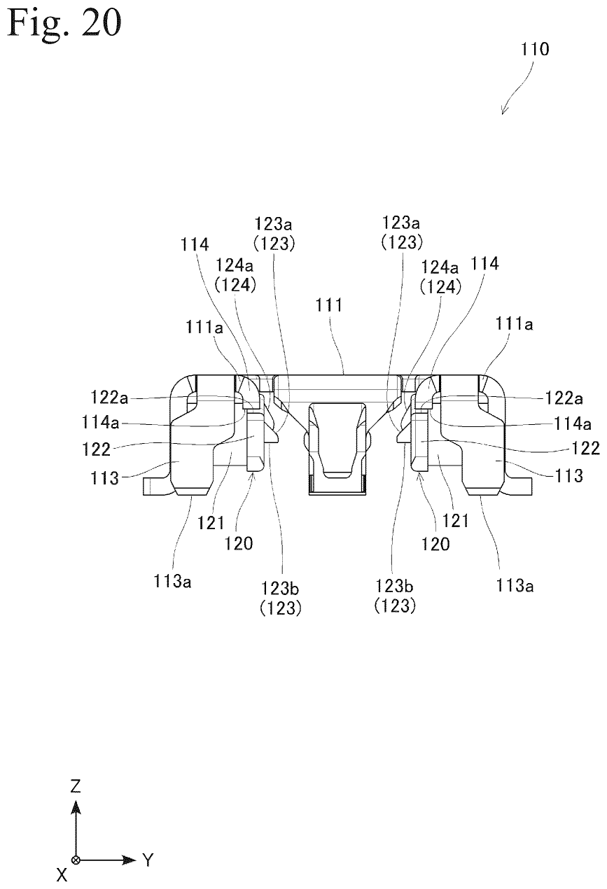

Next, with reference to FIGS. 13 to 20, a description will be made with respect to a detailed configuration of the additional member 110 including the locking mechanisms 120 in the connector 100. FIGS. 13 to 20 show the additional member 110 installed on the right side of the connector 100.

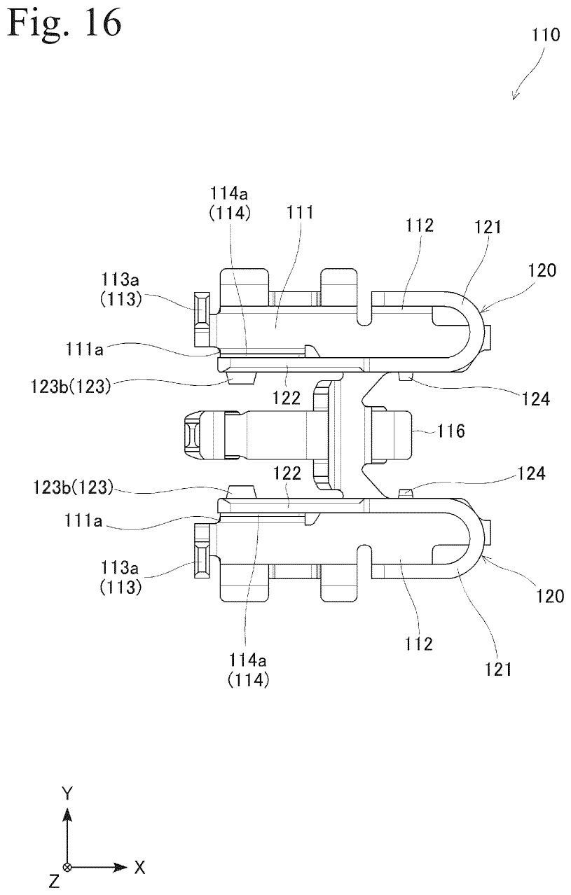

As shown in FIG. 16, the additional member 110 of the present embodiment includes two locking mechanisms 120 that are located to face each other in the front-rear direction, which is the second direction. Each of the two locking mechanisms 120 includes a spring portion 121, an extension portion 122, a locking portion 123, and an operating portion 124.

The spring portion 121 is a portion that is formed as a plate-like elastic member having a U-shape that is closed at the outer side of the connector 100 and open at an inner side thereof in the left-right direction, which is the first direction, when viewed in the up-down direction, which is the third direction. The spring portion 121 is configured such that an end of the U-shape on the outer side of the connector 100 in the front-rear direction, which is the second direction, is connected to a portion of the additional member 110 (in this example, a bent portion 112 to be described below) other than the locking mechanism 120 to form a fixed end, and an end of the U-shape on the inner side of the connector 100 in the front-rear direction, which is the second direction, is formed as a free end.

The extension portion 122 is a member that is continuous with the end formed as a free end of the U-shaped spring portion 121 on the inner side of the connector 100 in the front-rear direction, which is the second direction. The extension portion 122 is formed to extend in the left-right direction, which is the first direction, whereby the extension portion 122 can be displaced in the front-rear direction, which is the second direction, by an elastic force of the spring portion 121.

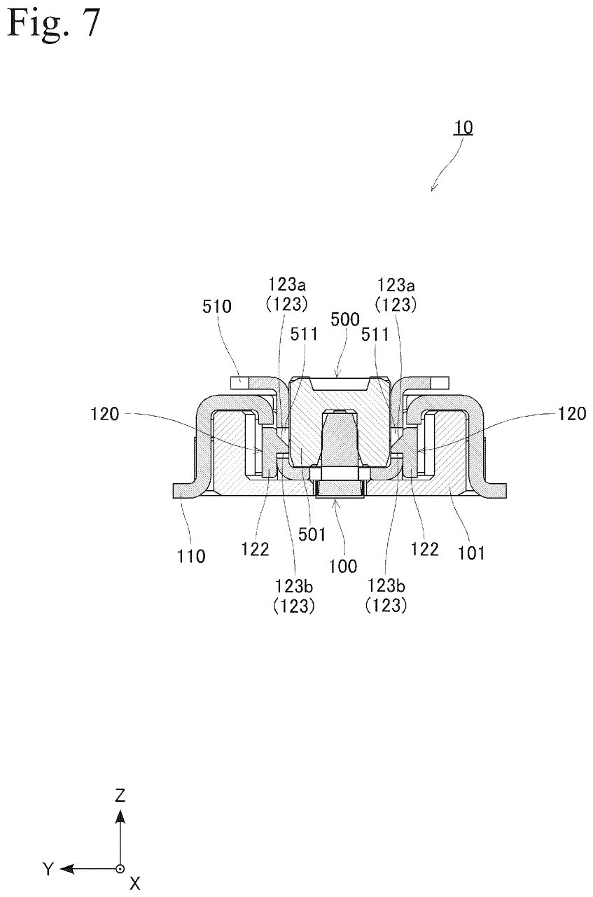

The locking portion 123 is formed on the inner side of the connector 100 in the front-rear direction which is the second direction of the extension portion 122. The locking portion 123 includes a slope 123a formed upward and a locking surface 123b that is a flat surface facing downward which is one of the up-down direction which is the third direction, as shown in a cross-sectional shape in FIG. 7. Therefore, when the mating connector 500 is fitted into the connector 100 by moving the mating connector 500 downward in the −Z direction relative to the connector 100, a surface of the mating additional member 510 of the mating connector 500 slides along the slope 123a of the locking portion 123 to push the locking portion 123, whereby the extension portion 122 is displaced outward in the front-rear direction, which is the second direction of the connector 100, the extension portion 122 is then displaced inward in the front-rear direction, which is the second direction of the connector 100, and the locking portion 123 is fitted into the locking hole 511 of the mating additional member 510 to achieve a smoothly engaged state by the slope 123a of the locking portion 123. In addition, when the locking portion 123 is once fitted into the locking hole 511 of the mating additional member 510, the locking surface 123b on the lower side of the locking portion 123 faces an inner surface of the locking hole 155 of the mating additional member 510, and even when the mating connector 500 is moved in a direction to be removed from the connector 100 in the state where the mating connector 500 is fitted into the connector 100, the locking surface 123b butts against the inner surface of the locking hole 511, and thus an upward movement of the mating connector 500 in the up-down direction, which is the third direction, is restricted. In other words, the locking surface 123b, which faces downward, of the locking portion 123 restricts the movement of the mating connector 500 in the up-down direction, which is the third direction, and prevents it from being removed from the connector 100.

As shown in FIG. 16, the operating portion 124 is located between the spring portion 121 and the locking portion 123 in the left-right direction, which is the first direction of the extension portion 122, and is formed on the inner side of the connector 100 in the front-rear direction, which is the second direction of the extension portion 122. In addition, the operating portion 124 is formed so as to be movable between a non-release position that is located when no pressing operation is undergone and a release position that is located when a pressing operation is undergone toward the outer side of the connector 100 in the front-rear direction, which is the second direction, and that is located closer to the outer side of the connector 100 than the non-release position in the front-rear direction which is the second direction. Regarding the non-release position and the release position of the operating portion 124, as shown in FIG. 7, the non-release position means a state in which the locking portion 123 is fitted into the locking hole 511 of the additional member 510, and the release position means a state in which the locking portion 123 moves from the locking hole 511 of the additional member 510 to the left and right outer sides of the connector 100 and comes out of the locking hole 511 to release the engaged state.

As shown in FIG. 13 and the like, the operating portion 124 is formed including a sliding slope 124a on an upper side. The operating portion 124 undergoes a pressing operation by an unlocking jig 700 (to be described below) to broaden outward in the front-rear direction, which is the second direction, and the pressing operation is an operation in which a pressing leg portion 701 of the unlocking jig 700 is pressed from the upside position in the −Z direction, which is the downside direction, against the sliding slope 124a of the operating portion 124. In the pressing operation, the pressing leg portion 701 applies a pressing force while sliding along the surface of the sliding slope 124a of the operating portion 124, whereby since the operating portion 124 includes the sliding slope 124a, an operation error is extremely unlikely to occur in which the operating portion 124 is erroneously pressed down by the pressing leg portion 701, and the pressing leg portion 701 can smoothly move the operating portion 124 from the non-release position to the release position.

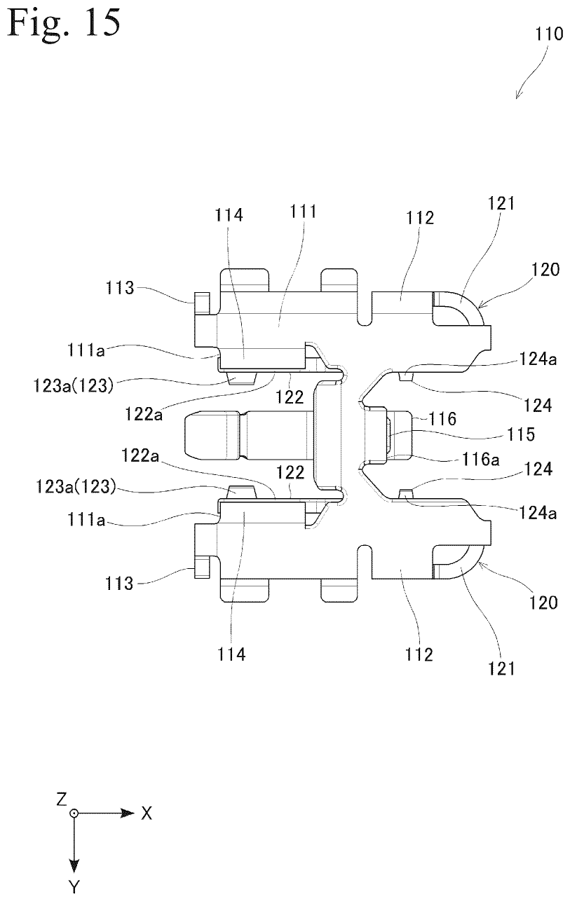

In the locking mechanism 120 of the present embodiment, the operating portion 124 is arranged on the side closer to the U-shaped spring portion 121, which functions as an elastic member, of the locking mechanism 120, that is, on a root side related to an elastic deformation of the locking mechanism 120 where the extension portion 122 is displaced, and since the locking portion 123 is arranged at a leading end, when the operating portion 124 undergoes the pressing operation to move from the non-release position to the release position, the locking portion 123, which moves in conjunction with the operating portion 124, moves with a larger amount of movement than the operating portion 124. In other words, the locking mechanism 120 of the present embodiment can set the amount of displacement of the operating portion 124 to be smaller than that of the related art while ensuring the necessary amount of displacement of the locking portion 123. Therefore, when the connector 100 is viewed in the third direction (up-down direction), the amount by which the non-release position of the operating portion 124 protrudes toward a side opposite to the release position in terms of the direction of movement, and the amount of dimension by which each of the operating portions 124 in FIG. 15 in the present embodiment protrudes inward in the second direction (front-rear direction) from the top plate 111 to be described below, that is, the dimension by which the operating portion 124 is exposed from the top plate 111 in waiting to receive a pressing operation, can be set smaller than in the related art.

The additional member 110 of the present embodiment shown in FIGS. 13 to 20 further includes a top plate 111 and a bent portion 112.

The top plate 111 is a member formed in a position at which the spring portion 121 and the extension portion 122 are at least partially covered when viewed in a downside direction which is one direction of the up-down direction which is the third direction, and formed to expand in parallel with the virtual plane formed by the left-right direction, which is the first direction, and the front-rear direction which is the second direction.

The bent portion 112 is a portion formed into a curved and bent shape to connect the end on the outer side of the connector 100 in the front-rear direction, which is the second direction, of the U-shape that constitutes the spring portion 121, and the top plate 111.

In other words, the locking mechanism 120 described above is formed in a manner that the end on the outer side of the spring portion 121 having the U-shape in the front-rear direction is connected to the lower end of the bent portion 112.

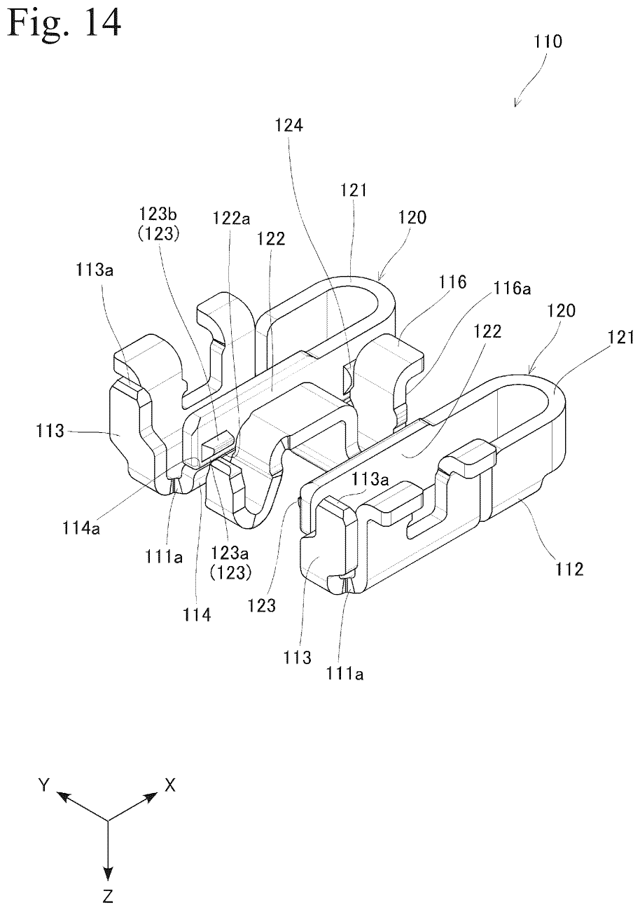

Furthermore, the additional member 110 of the present embodiment includes a hold-down 113. As shown in FIGS. 14, 17, and 20, the hold-down 113 is a portion that is formed continuously with an end 111a formed on the inner side of the connector 100 in the left-right direction, which is the first direction of the top plate 111, and is formed to extend from the end 111a in the downside direction (−Z direction) which is one direction of the up-down direction, which is the third direction.

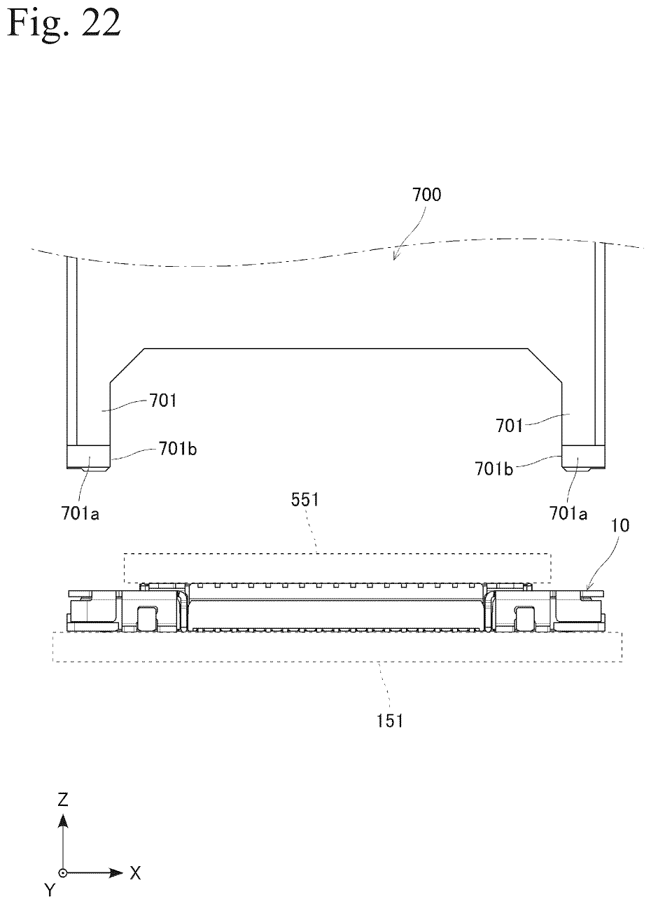

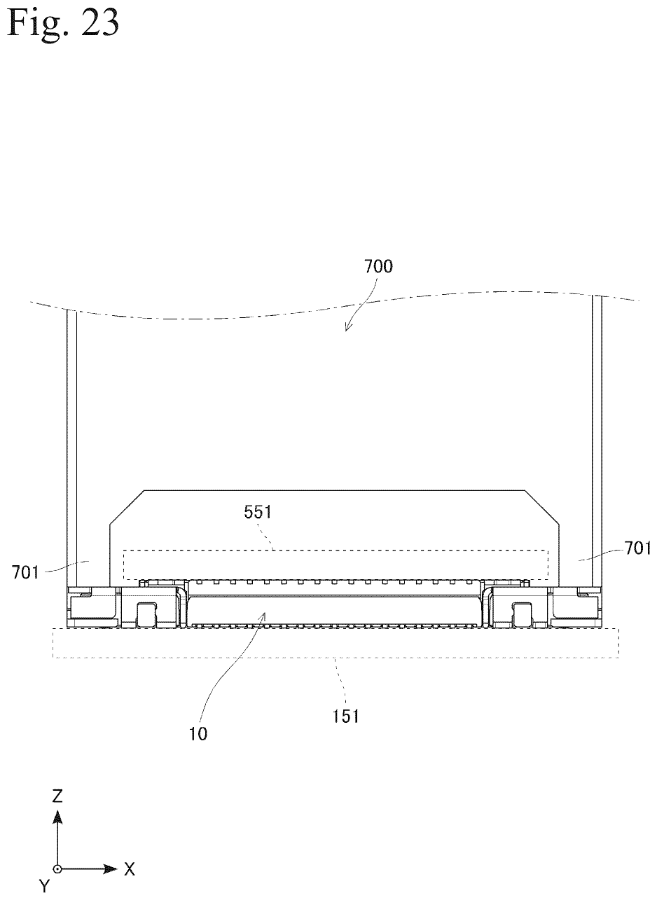

The hold-down 113 includes a soldering portion 113a at a terminal end opposite to the connection portion with the end 111a, that is, at a downside end, and, for example, as shown in FIGS. 22 and 23, when the underside of the connector 100 is placed on a second circuit board 151 arranged on a side in the downside direction which is one direction of the up-down direction, which is the third direction of the connector 100, the soldering portion 113a can be soldered to the second circuit board 151. Due to the soldering of the soldering portion 113a of the hold-down 113 to the second circuit board 151, the additional member 110 including the locking mechanism 120 receiving an upward external force when a worker particularly attempts to remove the mating connector 500 is more firmly attached to the second circuit board 151.

Furthermore, the additional member 110 of the present embodiment includes a restriction portion 114. In this example, as shown in FIGS. 13 to 15, 18, and 20, the restriction portion 114 is formed as a portion extending from the top plate 111 toward the vicinity of the extension portion 122, and includes a restricting surface 114a facing in the downside direction which is one direction of the up-down direction (third direction). That is, the restricting surface 114a is fixed to the top plate 111 and faces downward. On the other hand, regarding the extension portion 122, a surface of a portion of the extension portion 122 facing the restricting surface 114a is formed as a restricted surface 122a facing in the upside direction which is the other direction of the up-down direction which is the third direction. Then, when the operating portion 124 is at the non-release position and no upward external force is being applied to the locking mechanism 120 including the extension portion 122, the restricting surface 114a and the restricted surface 122a face each other with a gap therebetween, and when an upward external force is applied to the extension portion 122, which is formed with the locking portion 123, to attempt to forcibly remove the mating connector 500 in a state where the locking portion 123 is fitted into the locking hole 511 of the mating connector 500, the restricted surface 122a butts against the restricting surface 114a. When the restricted surface 122a butts against the restricting surface 114a in this manner, irregular upward movement of the extension portion 122 is strongly restricted by the restriction portion 114. That is, the restriction portion 114 is formed such that the locking mechanism 120 acts more reliably. Since the additional member 110 of the present embodiment includes the restriction portion 114, breakage to the locking mechanism 120 due to the excessive operation can be suitably prevented.

The locking portion 123 and the restricted surface 122a formed on the extension portion 122 are preferably arranged such that positions thereof in the X direction (left-right direction), that is, the first direction on the extension portion 122 at least partially overlap (see FIG. 13 and the like). The locking portion 123, to which the upward force is applied, and the restricted surface 122a, to which the downward force is applied by butting against the restricting surface 114a are arranged in an overlapping position in the extension direction of the extension portion 122, that is, the X direction (first direction), whereby the occurrence of torque or bending stress in the extension portion 122 can be prevented, the restriction portion 114 can be effectively acted, and the occurrence of malfunctions such as breakage of the locking mechanism 120 can be suitably prevented.

The description has been made above with respect to the detailed configuration of the total of four locking mechanisms 120 which are provided two by two for each of the two additional members 110 provided in the connector 100. Next, an operation will be described when the mating connector 500 is fitted into or removed from the connector 100.

When the mating connector 500 is fitted into the connector 100, the mating connector 500 moves in the −Z direction which is the downside direction, as shown in FIG. 8, to fit the mating connector 500 into the connector 100. At this time, since the mating connector 500 is pushed into the connector 100 while the surface of the mating additional member 510 slides along the slope 123a of the locking portion 123, the extension portion 122 is displaced outward in the front-rear direction, which is the second direction of the connector 100, the extension portion 122 is then displaced to return inward in the front-rear direction, which is the second direction of the connector 100, and the locking portion 123 is fitted into the locking hole 511 of the additional member 510. By such an operation, the locking hole 511 and the locking portion 123 are engaged with each other, as shown in FIG. 7 to achieve a locked state in which the engagement between the mating connector 500 and the connector 100 is held.

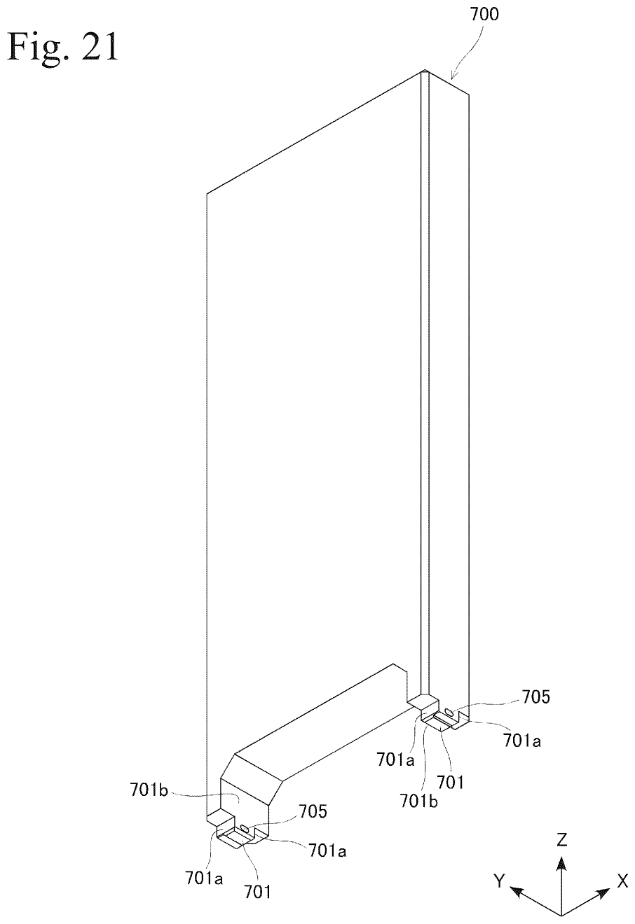

The locked state between the mating connector 500 and the connector 100 is released using the unlocking jig 700. The unlocking jig 700 of the present embodiment is shown in FIG. 21. That is, the total of four operating portions 124 can be simultaneously operated by the unlocking jig 700, the four operating portions being provided in the total of four locking mechanisms 120, respectively, which are provided two by two for each of the two additional members 110 provided in the connector 100.

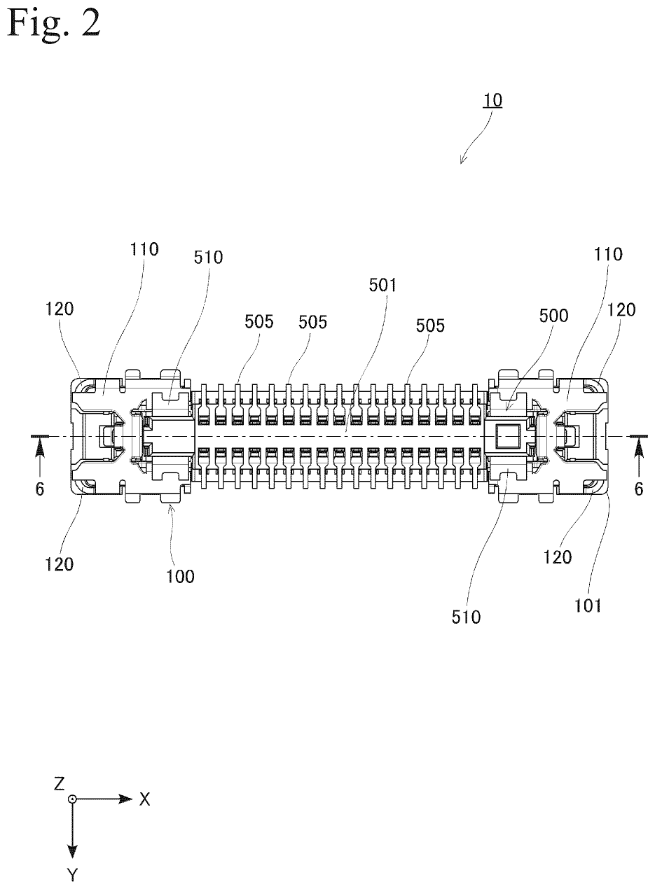

The unlocking jig 700 is a member including two pressing leg portions 701 that protrudes downward to lower left and right ends in the up-down direction (Z direction) of an elongated cubic member, as shown in FIG. 21, in a posture to be used with respect to the connector assembly 10 in which the connector 100 and the mating connector 500 are fitted into each other. Each of the pressing leg portions 701 includes a total of two pressing operation surfaces 701a facing outward on both sides in the front-rear direction (Y direction). That is, the unlocking jig 700 includes a total of four pressing operation surfaces 701a. The unlocking jig 700 is used by being moved in the −Z direction, which is the downside direction, from the upside position of the connector assembly 10 in a state where the mating connector 500 is fitted into the connector 100, so as to change from the state shown in FIG. 22 to the state shown in FIG. 23. As shown in FIGS. 1 and 2, the connector assembly 10 has a space in which a gap between the two locking mechanisms 120 is open upward which are provided on each of the additional members 110 to face each other in the front-rear direction in the state where the connector 100 and the mating connector 500 are fitted into each other. The two pressing leg portions 701 of the unlocking jig 700 are simultaneously inserted from above into each of the two spaces, which are open upward, on both sides in the left-right direction of the connector assembly 10 being in the fitted state. At this time, the amount of protrusion of the operating portion 124 protruding into each of the spaces, more specifically, the dimension of the operating portion 124 that is exposed inward in the Y direction (front-rear direction) from the top plate 111 when viewed from above in the Z direction is significantly smaller than that of the related art (see FIG. 15). When the unlocking jig 700 is pressed against such a connector assembly 10 in the −Z direction, which is the downside direction, as shown in FIG. 23, the total of four pressing operation surfaces 701a provided two by two on each of the two pressing leg portions 701 of the unlocking jig 700 press the total of four operating portions 124 provided one by one in each of the locking mechanisms 120 of the connector 100 to broaden outward in the front-rear direction, which is the second direction, and move each of the operating portions from the non-release position to the release position. Thus, the extension portion 122 moves outward in the front-rear direction, which is the second direction, to open with the U-shaped spring portion 121 as a fulcrum, whereby the locking portion 123 farther from the fulcrum along the extension portion 122 than the operating portion 124 moves in conjunction with the operating portion 124 in the same direction as the movement of the operating portion 124, and moves with a larger amount of movement than the operating portion 124 that moves from non-release position to the release position. In a state of starting such an operation, that is, in a state where the connector assembly 10 is waiting for the insertion of the unlocking jig 700, the dimension of the operating portion 124 exposed from the top plate 111 is smaller as described above, and thus an operation error is extremely unlikely to occur in which the operating portion 124 or the extension portion 122 is erroneously pressed down by the pressing leg portion 701. Furthermore, as shown in FIGS. 13 and 15, since the exposed portion of the operating portion 124, which is exposed in a small dimension from the top plate 111, is the sliding slope 124a, when the pressing leg portion 701 of the unlocking jig 700 is pressed against the sliding slope 124a in the −Z direction, which is the downside direction, from the upside direction, the pressing leg portion 701 slides along the surface of the sliding slope 124a and presses the operating portion 124 to broaden outward in the front-rear direction, which is the second direction, whereby the pressing leg portion 701 can smoothly move the operating portion 124 from the non-release position to the release position. Furthermore, according to the configuration of the present embodiment, the amount of operation (amount of movement) required to move the operating portion 124 to the non-release position is small, and thus the operability of unlocking is improved and lighter compared to the related art. As the locking portion 123 described above moves, the engagement of the locking portion 123 fitted into the locking hole 511 of the mating additional member 510 is released, that is, the locking surface 123b no longer contacts with or faces the inner surface of the locking hole 511 in the up-down direction, and the locking portion 123 is open at the upper part, making it possible to move upward. From the state where the engagement between the locking hole 511 and the locking portion 123 is released, that is, the state shown in FIG. 23, the operator can lift the mating connector 500 in the +Z direction, which is the upside direction, and can remove the mating connector 500 from the connector 100.

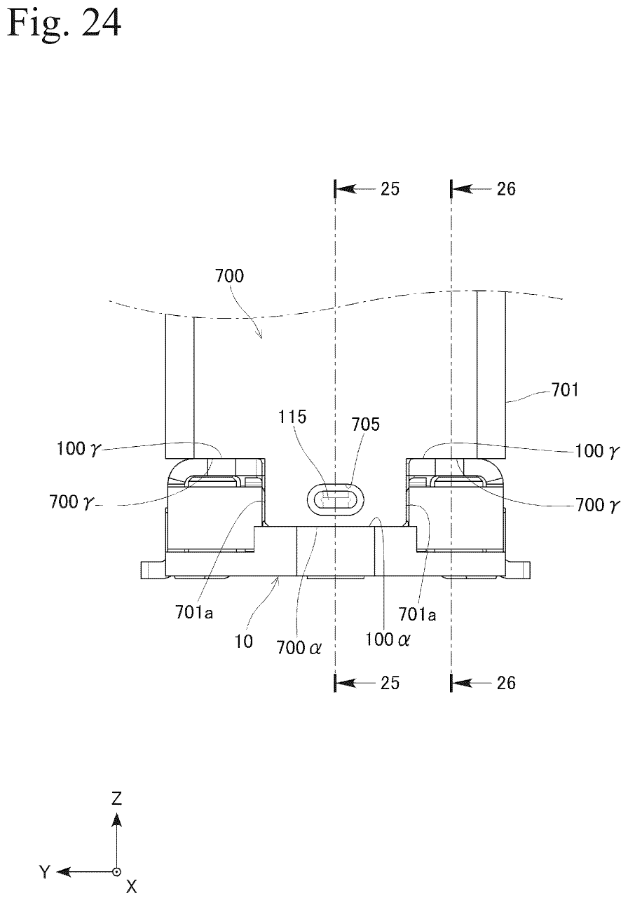

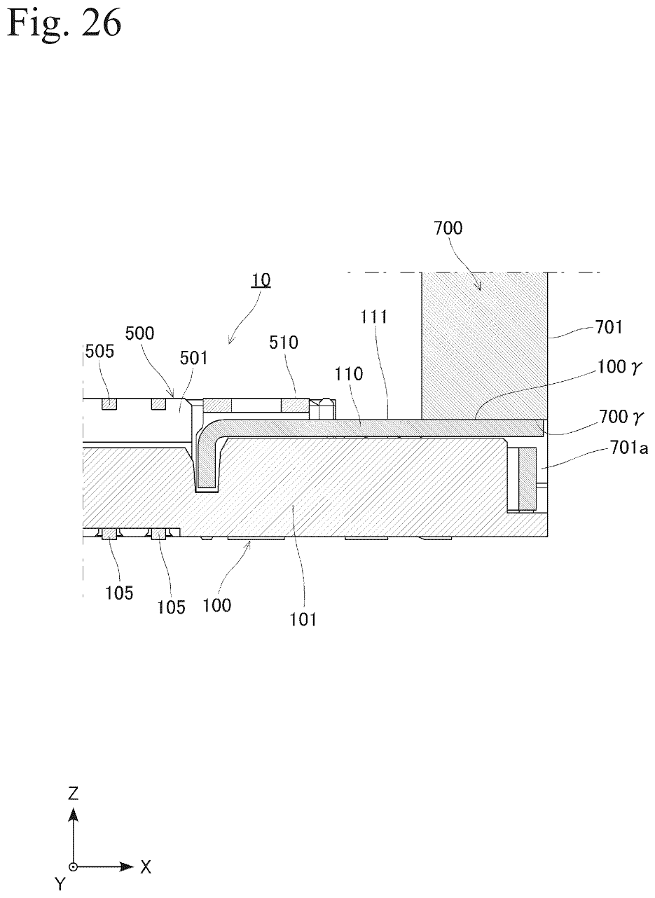

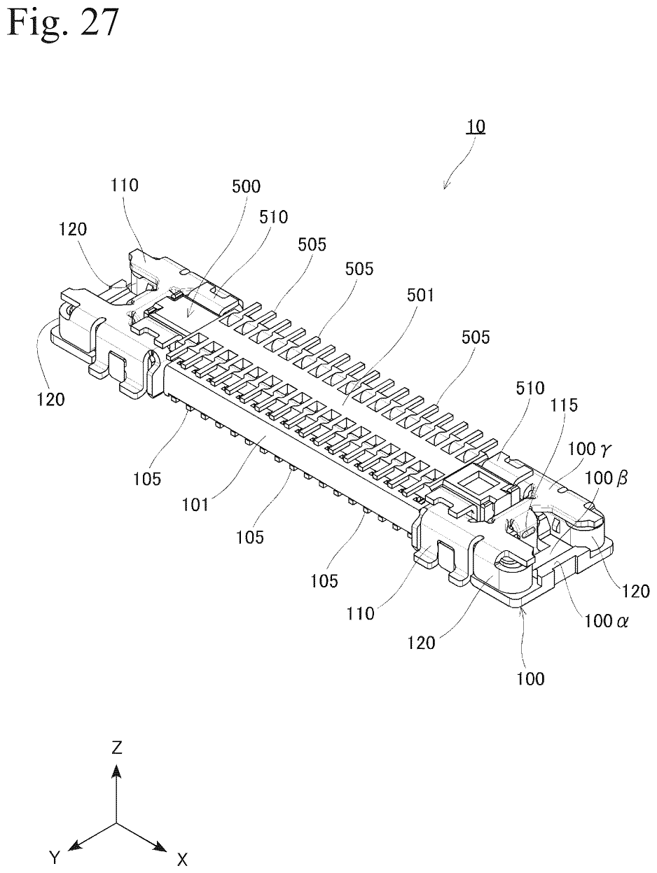

As shown in FIGS. 24 to 27, the connector 100 of the present embodiment includes three abutted surfaces 100α, 100β, and 100γ which are three flat surfaces having different heights in the Z direction (up-down direction), that is, having different positions in the third direction and facing perpendicularly upward in the z direction. Specifically, the abutted surfaces 100α and 100β are formed with different heights from each other in the up-down direction in a portion, which is located below a space that is open upward between the two locking mechanisms 120 facing each other in the front-rear direction, of a housing 101, and in this example, the abutted surface 100α is located relatively higher and the abutted surface 100β is located relatively lower. The abutted surface 100γ is configured as an upper surface of the top plate 111 of the locking mechanism 120, and is located at the highest position in the up-down direction among the three abutted surfaces. On the other hand, the pressing leg portion 701 of the unlocking jig 700 of the present embodiment includes three abutting surfaces 700α, 700β, and 700γ which are three flat surfaces having different heights in the Z direction (up-down direction) in the posture to be used with respect to the connector assembly 10, that is, having different positions in the third direction and all facing perpendicularly downward in the z direction.

The three abutting surfaces 700α, 700β, and 700γ correspond to the three abutted surfaces 100α, 100β, and 100γ in terms of positions on the XY plane and positions (heights) in the Z direction. That is, as shown in FIGS. 24 to 27, in the present embodiment, when the unlocking jig 700 is pressed against the connector assembly 10 to perform the unlocking operation, the three abutting surfaces 700α, 700β, and 700γ are in surface contact with the three abutted surfaces 100α, 100β, and 100γ, respectively, to form three contact surfaces having different heights in the up-down direction. In this way, a plurality of contact surfaces between the connector 100, which receives a pressing force in the −Z direction being the downside direction from the unlocking jig 700, and the unlocking jig 700 are provided, whereby the posture of the unlocking jig 700 in contact with the connector 100 can be stabilized, and thus malfunctions such as twisting of the unlocking jig 700 can be suitably prevented. In the present embodiment, a total of three abutted surfaces 100α, 100β, and 100γ including two on the housing 101 of the connector 100 and one on the top plate 111 are provided to form a total of three contact surfaces, but, in the present invention, at least two contact surfaces may be provided between the connector and the unlocking jig. When there are two contact surfaces, for example, with respect to the connector 100, two abutted surfaces having different heights may be provided on the housing 101, or one abutted surface may be provided on the housing 101 and the other may be provided on the top plate 111.

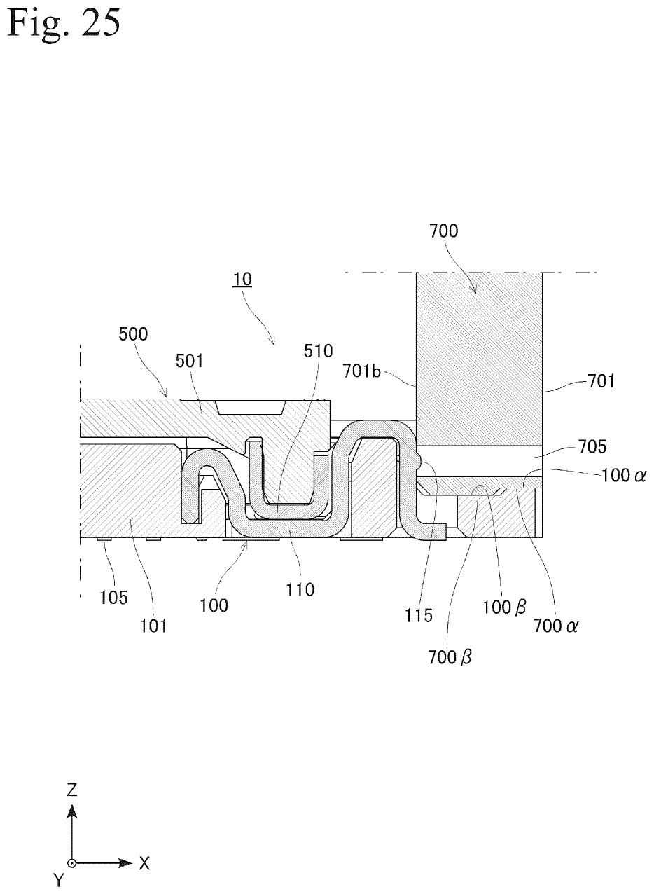

In the present embodiment, as shown in FIG. 13 and the like, the additional member 110 of the connector 100 is provided with a sliding portion 116 that is connected to the top plate 111 and extends in the downside direction (−Z direction). The sliding portion 116 is formed with a connector-side sliding surface 116a that slides against the unlocking jig 700 when the unlocking jig 700 is inserted and is a flat surface parallel to the up-down direction (Z direction). The connector-side sliding surface 116a is perpendicular to the X direction, and faces outward in the X direction, that is, in the left-right direction of the connector 100. The sliding portion 116 has deformable elasticity in a direction perpendicular to the connector-side sliding surface 116a, that is, in the X direction, while being fixed to the top plate 111. The connector-side sliding surface 116a is formed with a connector-side operation feeling imparting portion 115 as a protrusion portion that protrudes from the connector-side sliding surface 116a in the present embodiment. On the other hand, as shown in FIGS. 21 and 25, the pressing leg portion 701 of the unlocking jig 700 includes a jig-side sliding surface 701b that is perpendicular to the X direction and faces inward in the X direction, that is, in the left-right direction of the connector 100, when the pressing leg portion 701 is inserted from above into the gap between the two locking mechanisms 120 facing each other in the front-rear direction. As shown in FIGS. 21, 24, and 25, the jig-side sliding surface 701b is formed with a jig-side operation feeling imparting portion 705 as a recess portion formed in the jig-side sliding surface 701b in the present embodiment, more specifically, as a through hole that penetrates the pressing leg portion 701 perpendicularly from the jig-side sliding surface 701b in this example.

When the unlocking jig 700 is moved to the downward side (in the −Z direction) relative to the connector assembly 10 to perform the unlocking operation, as can be seen from FIG. 25, the jig-side sliding surface 701b and the connector-side sliding surface 116a are in surface contact with each other and slide such that the unlocking jig 700 advances to the downward side (in the −Z direction). As a result of the sliding, as shown in FIG. 25, the connector-side operation feeling imparting portion 115, which is the protrusion portion, enters into the jig-side operation feeling imparting portion 705, which is the recess portion, and at that time, the elasticity of the sliding portion 116 gives click feeling as a slight impact. That is, the operator, who operates the unlocking jig 700, can receives click feeling indicating that the unlocking jig 700 is sufficiently pressed against the connector assembly 10 as shown in FIG. 25 and the operating portion 124 moves to achieve unlocking. It is preferable that the protrusion portion of the connector-side operation feeling imparting portion 115 and the recess portion of the jig-side operation feeling imparting portion 705 are formed such that there is an appropriate amount of play in the Z direction when the protrusion portion fits into the recess portion. In this example, the recess portion of the jig-side operation feeling imparting portion 705 is formed as a through hole, but the recess portion may be formed as a dent hole in the jig-side sliding surface 701b. Furthermore, the protrusion portion and the recess portion may be interchanged, whereby the connector-side operation feeling imparting portion may be formed as a recess portion, and the jig-side operation feeling imparting portion may be formed as a protrusion portion.

When being used with the connector assembly 10 as shown in FIG. 23, the unlocking jig 700 of the present embodiment has preferably an outline shape that does not deviates from the outer shape of the connector assembly 10 when viewed in the up-down direction which is the third direction. The outline shape of the unlocking jig 700 is formed with dimensions so as not to deviate from the outer shape of the connector assembly 10, whereby interference with other components installed on the board can be avoided to contribute to improving the operability, for example.

Although the preferred embodiment of the present invention has been described above, the technical scope of the present invention is not limited to the scope described in the above-described embodiment. The above-described embodiment can be variously modified and improved.

For example, the connector assembly 10 configured by the mating connector 500 and the connector 100 of the above-described embodiment is particularly useful when being used as a board-to-board connector that electrically connects a first circuit board 551 on which the mating connector 500 is mounted and a second circuit board 151 on which the connector 100 is mounted, as shown in FIGS. 22 and 23.

For example, in the above-described embodiment, a configuration has been adopted in which the mating connector 500 is configured as a plug connector, the connector 100 is configured as a receptacle connector, and the locking mechanism 120 is provided for the connector 100. However, the connector may be either a plug connector or a receptacle connector in the range in which the locking mechanism according to the present invention exerts the same effects as those of the above-described embodiment. In the present invention, the mating connector and the connector include all types of connectors.

It will be apparent from the claims that such modified or improved forms may also be included within the technical scope of the present invention.

### REFERENCE SIGNS LIST

10 connector assembly
100 connector
101 housing
105 plurality of terminals
110 additional member
111 top plate
111a end
112 bent portion
113 hold-down
113a soldering portion
114 restriction portion
114a restricting surface
115 connector-side operation feeling imparting portion (protrusion portion)
116 sliding portion
116a connector-side sliding surface
120 locking mechanism
121 spring portion
122 extension portion
122a restricted surface
123 locking portion
123a slope
123b locking surface
124 operating portion
124a sliding slope
151 second circuit board (board)
100α abutted surface
100β abutted surface
100γ abutted surface
500 mating connector
501 mating housing
505 plurality of mating terminals
510 mating additional member
511 locking hole
551 first circuit board (board)
700 unlocking jig
701 pressing leg portion
701a pressing operation surface
701b jig-side sliding surface
705 jig-side operation feeling imparting portion (recess portion)
700α abutting surface
700β abutting surface
700γ abutting surface

1. A connector that, by moving a mating connector in a third direction orthogonal to a virtual plane formed by a first direction and a second direction that are orthogonal to each other, is fitted with or removed from the mating connector, the connector comprising:
a housing;
a plurality of terminals held in the housing and arranged in a direction along the first direction;
two additional members held in the housing and located at both ends of the housing in the first direction, each of the two additional members including
two locking mechanisms located to face each other in the second direction, each of the two locking mechanisms including
a spring portion being a plate elastic member having a U-shape that is closed at an outer side of the connector and open at an inner side thereof in the first direction when viewed in the third direction, an end of the U-shape on the outer side of the connector in the second direction being formed as a fixed end, an end of the U-shape on the inner side of the connector in the second direction being formed as a free end,
an extension portion formed to be continuous with the end on the inner side of the connector in the second direction, which is formed as the free end of the spring portion having the U-shape, and to extend in the first direction, the extension portion being displaced in the second direction by an elastic force of the spring portion,
a locking portion formed on the inner side of the connector in the second direction of the extension portion, and including a locking surface that faces one side in the third direction, and
an operating portion located between the spring portion and the locking portion in the first direction of the extension portion, and formed on the inner side of the connector in the second direction of the extension portion,
wherein the operating portion moves between a non-release position and a release position that, when a pressing operation is undergone toward the outer side of the connector in the second direction, is located closer to the outer side of the connector than the non-release position in the second direction, and
when the operating portion moves from the non-release position to the release position, the locking portion, which moves in conjunction with the operating portion, moves with a larger amount of movement in the second direction than the operating portion.

2. The connector according to claim 1, wherein
each of the two additional members further includes a top plate and a bent portion,
the top plate is formed at a position at which the spring portion and the extension portion are at least partially covered when viewed along the one side in the third direction, and expands in parallel with a virtual plane formed by the first direction and the second direction, and
the bent portion is formed into a curved and bent shape to connect the end on the outer side of the connector in the second direction, of the U-shape that constitutes the spring portion, and the top plate.

3. The connector according to claim 2, wherein
each of the two additional members further includes a hold-down,
the hold-down is continuous with an end of the top plate formed on the inner side of the connector in the first direction, and extends from the end to the one side in the third direction,
the hold-down includes a soldering portion at a terminal end opposite to a side connected to the end, and
when the connector is placed on a board arranged on a side facing the one side in the third direction, the soldering portion is soldered to the board.

4. The connector according to claim 2, wherein
each of the two additional members further includes a restriction portion,
the restriction portion includes a restricting surface that is fixed to the top plate and faces the one side in the third direction,
the extension portion is formed with a restricted surface that faces the other side in the third direction,
when the operating portion is at the non-release position, the restricting surface faces the restricted surface in the third direction, and
when the restricted surface butts against the restricting surface in the third direction, movement of the locking portion toward the other side in the third direction is restricted.

5. The connector according to claim 4, wherein
the locking portion and the restricted surface at least partially overlap each other in positions in the first direction on the extension portion.

6. A connector device comprising:
the connector according to claim 1; and
an unlocking jig, wherein
the connector includes, on each of both sides in the first direction, at least two abutted surfaces, which are flat surfaces perpendicular to the third direction and facing the other side in the third direction, on the housing or the two additional members, the at least two abutted surfaces being arranged at different positions in the third direction,
the unlocking jig includes two pressing leg portions that are inserted into a gap between the two locking mechanisms, which are located to face each other in the second direction and are provided on each of the two additional members, by moving to approach toward the connector along the one side in the third direction,
each of the two pressing leg portions includes two pressing operation surfaces that are located to face outward on both sides in the second direction when being inserted into the gap between the two locking mechanisms and move each of the two operating portions of the two locking mechanisms from the non-release position to the release position by inserting the two pressing leg portions, and
each of the two pressing leg portions further includes at least two abutting surfaces, which are flat surfaces perpendicular to the third direction and facing the one side, when being inserted into the gap between the two locking mechanisms, the at least two abutting surfaces being arranged at different positions in the third direction and abutting against the at least two abutted surfaces, respectively, by inserting the pressing leg portions.

7. A connector device comprising:
the connector according to claim 2; and
an unlocking jig, wherein
the connector includes, on each of both sides in the first direction, at least two abutted surfaces, which are flat surfaces perpendicular to the third direction and facing the other side in the third direction, on the housing or the top plate, the at least two abutted surfaces being arranged at different positions in the third direction,
the unlocking jig includes two pressing leg portions that are inserted into a gap between the two locking mechanisms, which are located to face each other in the second direction and are provided on each of the two additional members, by moving to approach toward the connector along the one side in the third direction,
each of the two pressing leg portions includes two pressing operation surfaces that are located to face outward on both sides in the second direction when being inserted into the gap between the two locking mechanisms and move each of the two operating portions of the two locking mechanisms from the non-release position to the release position by inserting the two pressing leg portions, and
each of the two pressing leg portions further includes at least two abutting surfaces, which are flat surfaces perpendicular to the third direction and facing the one side, when being inserted into the gap between the two locking mechanisms, the at least two abutting surfaces being arranged at different positions in the third direction and abutting against the at least two abutted surfaces, respectively, by inserting the pressing leg portions.

8. The connector device according to claim 6, wherein
each of the two additional members of the connector includes a connector-side sliding surface that is a flat surface perpendicular to the first direction and facing the outer side of the connector in the first direction and is elastically deformed in the first direction, the connector-side sliding surface being formed with a connector-side operation feeling imparting portion which is either a protrusion portion or a recess portion,
each of the two pressing leg portions of the unlocking jig includes a jig-side sliding surface that is a flat surface perpendicular to the first direction and facing the inner side of the connector in the first direction when being inserted into the gap between the two locking mechanisms, the jig-side sliding surface being formed with a jig-side operation feeling imparting portion which is either a protrusion portion or a recess portion, and
when the at least two abutted surfaces abut against the at least two abutting surfaces by inserting the pressing leg portion into the gap between the two locking mechanisms, the connector-side operation feeling imparting portion and the jig-side operation feeling imparting portion impart operation feeling to an operator, who operates the unlocking jig, by being fitted with each other.
